(19) United States
(12) Patent Application Publication
(10) Pub. No.: US 2005/0226580 A1
(43) Pub. Date: Oct. 13, 2005

(54) Optical fiber for handling higher powers

(76) Inventors: Bryce N. Samson, Manchester, CT (US); Adrian Carter, Bulli (AU)

Correspondence Address: NUFERN, 7 AIRPORT PARK ROAD, EAST GRANBY, CT, 06026, US

(21) Appl. No.: 10/820,475

(22) Filed: Apr. 8, 2004

(51) Int. Cl. G02B 6/22

(52) U.S. Cl. 385/127

(57) ABSTRACT

An optical fiber comprising a core having an outer region disposed about an inner region and an intensity profile having a highest intensity that is less than the highest intensity of a Gaussian intensity profile that is normalized to have the same power as the intensity profile. The outer region can comprise an index of refraction that is greater than an index of refraction comprised by the inner region. The outer region can comprise a first concentration of a selected rare earth and any concentration of the selected rare earth comprised by the inner region can be less than the selected concentration. The inner region can include first and second rare earths and the outer region can be photosensitive. A second cladding can be included. A fiber according to the invention can be birefringent and can include, for example, at least one longitudinally extending stress inducing region for creating birefringence.

### FIELD OF THE INVENTION

The present invention relates to optical waveguides, and more particularly, to optical fibers capable of handling higher powers.

### BACKGROUND

Optical fiber lasers and amplifiers can provide a flexible, rugged and simple source of high quality light (e.g., light having one or more of low divergence, high coherence, a narrow spectrum, a narrow beam diameter or a low M² parameter). However, they cannot typically produce as much power as other types of lasers or laser amplifiers, such as bulk solid state devices, gas lasers, or diode lasers. This can be due, at least in part, to limits imposed by the optical fiber.

Nonlinear processes, such as stimulated Brillouin scattering (SBS) and stimulated Raman scattering (SRS), can limit the amount of power that an optical fiber can handle, thus limiting the power output of optical fiber lasers and amplifiers. Though these processes are complex, the detrimental effects of one or both can be reduced by limiting the power density in the core of the fiber. This can be accomplished by using a fiber having a core having a larger diameter and/or a lower a lower numerical aperture (NA), such that the fiber has a larger mode field diameter (MFD). The refractive index profile of an optical fiber can also be tailored (e.g., modified from the standard “step” index profile) to provide a larger MFD. Essentially, the power of the light propagating along the fiber is more spread out, such that the power density in any given area of the fiber is reduced.

Although the foregoing techniques can be helpful, they have drawbacks and limitations, and do not provide additional functionality that can be useful in realizing practical higher power optical devices, such as, for example, higher power optical fiber lasers and amplifiers and optical devices that use such lasers and amplifiers.

Accordingly, it is an object of the present invention to address one or more disadvantages or drawbacks of the prior art.

### SUMMARY

In one aspect, the invention provides an optical fiber that includes a core comprising an outer region disposed about an inner region, where the inner region comprises a first index of refraction and the outer region comprises a second index of refraction that is greater than the first index of refraction; a cladding disposed about the core; a fundamental mode having an intensity profile at a first wavelength wherein the highest intensity of the intensity profile is no greater than 75% of the highest intensity of a Gaussian intensity profile normalized so as to have the same power as the intensity profile; and the outer region of the core comprises a first concentration of a selected rare earth and any concentration of the selected rare earth comprised by the inner region is less than the first concentration.

Note that in one example of the practice of the invention, the highest intensity is no greater than 60% of the highest intensity of the Gaussian intensity profile, and in another example the highest intensity of the intensity profile is no greater than 50% of the highest intensity of the Gaussian intensity profile. The inner region can be substantially free of the selected rare earth. The selected rare earth can comprise erbium. The outer region can comprise erbium and ytterbium. The inner region can be photosensitive, and the outer region, if photosensitive at all, can in one practice have less than 50% of the photosensitivity of the inner region, and in another practice have less than 10% of the photosensitivity of the inner region. The inner region can comprise a selected concentration in weight percent of a selected photosensitive material, and in one practice of the invention any concentration of the selected photosensitive material comprised by the outer region is less than the selected concentration, such as, for example, by being no greater than 50% of the selected concentration.

The optical fiber can include a second cladding disposed about the cladding such that the cladding can guide light. The fiber can be birefringent and extend along a longitudinal axis, where the fiber comprises at least one longitudinally extending region for inducing stress. Such a fiber can have a second cladding. The second cladding can be microstructured, and, for example, comprise longitudinally extending voids.

In another aspect the invention provides an optical fiber that includes a core comprising an outer region disposed about an inner region, where the inner region comprises a first index of refraction and the outer region comprises a second index of refraction that is greater than the first index of refraction; a cladding disposed about the core; a fundamental mode having an intensity profile at a first wavelength wherein the highest intensity of the intensity profile is no greater than 75% of the highest intensity of a Gaussian intensity profile normalized so as to have the same power as the intensity profile; and the outer region of the core can be photosensitive and the inner region can comprise a first rare earth and a second rare earth that is different than the first rare earth, where the inner region, if photosensitive at all, has no greater than 50% of the photosensitivity of the outer region.

The outer region comprises a concentration of GeO₂, and can, for example, also include at least one of a concentration of B₂O₃ and a concentration of fluorine. The inner region can comprise erbium and ytterbium. The inner region, if photosensitive at all, can have, in one practice of the invention, no greater than 25% of the photosensitivity of the outer region; in another practice, the inner region, if photosensitive at all, has no more than 10% of the photosensitivity of the outer region. Any concentration comprised by the outer region of one of the first and second rare earths can be substantially less than the concentration of the one of the first and second rare earths comprised by the inner region.

The outer region can be substantially free of any rare earth. The optical fiber can include a second cladding disposed about the cladding such that the cladding can guide light. The fiber can be birefringent and extend along a longitudinal axis, and the fiber can comprise at least one longitudinally extending region for inducing stress, such as, for example, when the fiber has the second cladding. The second cladding can be microstructured, and can comprise longitudinally extending voids.

In an additional aspect, the invention provides an optical fiber comprising a core extending along a longitudinal axis; a cladding disposed about the core; a refractive index profile comprising outer sections disposed about an inner section comprising a first index of refraction, the outer sections each having an index of refraction that is greater than the first index of refraction such that the optical fiber comprises at a first wavelength a fundamental mode having an intensity profile having a highest intensity that is no greater than 75% of the highest intensity of a Gaussian intensity profile normalized to have the same power as the intensity profile; and the fiber can have a birefringence of at least 1×10⁻⁴ at wavelength of 633 nm.

The cladding can have a thermal coefficient of expansion (TCE), and the fiber can include at least one longitudinally extending region having a TCE that is different than the TCE comprised by the cladding, where the region can induce stress for creating birefringence. The fiber can have a second cladding disposed about the cladding such that the cladding can guide light. The second cladding can comprise a plurality of features having an index of refraction different than the index of refraction of the material of the second cladding disposed about the features. The features can comprise voids.

In yet a further example, the invention provides an optical fiber comprising a core comprising an outer region disposed about an inner region; a cladding disposed about the core; and a fundamental mode having an intensity profile that has a reduced highest intensity relative to a Gaussian intensity normalized to have the same power as the intensity profile. One of the inner and outer regions of the core comprises a first concentration of a selected rare earth and the other of the regions comprises a second concentration of a selected photosensitive material, where any concentration of the selected rare earth comprised by the other region is less than the first concentration and any concentration of the selected photosensitive material comprised by the one region is less than the second concentration, and when the selected photosensitive material comprises GeO₂ and the outer region comprises the second concentration of the selected photosensitive material, the second concentration is greater than 5 weight percent.

The outer region can comprise the second concentration of the selected photosensitive material. The outer region can be substantially free of the selected rare earth. The inner region can be substantially free of the selected photosensitive material. The outer region can be substantially free of the selected rare earth when the inner region is substantially free of the selected photosensitive material.

The outer region can comprise the first concentration of the selected rare earth. The outer region can be substantially free of the selected photosensitive material. The inner region can be substantially free of the selected rare earth. The outer region is substantially free of the selected photosensitive material when in the inner region is substantially free of the selected rare earth.

In one practice the highest intensity of the intensity profile is no greater than 75% of the highest intensity of the normalized Gaussian intensity profile.

Further advantages, novel features, and objects of the invention will become apparent from the following detailed description of non-limiting embodiments of the invention when considered in conjunction with the accompanying FIGURES, which are schematic and which are not necessarily drawn to scale. For purposes of clarity, not every component is labeled in every one of the following FIGURES, nor is every component of each embodiment of the invention shown where illustration is not considered necessary to allow those of ordinary skill in the art to understand the invention.

### BRIEF DESCRIPTION OF THE DRAWINGS

FIG. 1 illustrates a cross section of an optical fiber according to the present invention.

FIG. 2 schematically illustrates one example of possible refractive index and intensity profiles for the fiber shown in FIG. 1.

FIG. 3 is a comparison between the intensity profile shown in FIG. 2 and a normalized Gaussian profile.

FIG. 4 illustrates one embodiment of an optical fiber which includes longitudinally extending regions.

FIG. 5 illustrates a further embodiment of an optical fiber according to the present invention; and

FIG. 6 illustrates an additional embodiment of an optical fiber according to the present invention.

### DETAILED DESCRIPTION

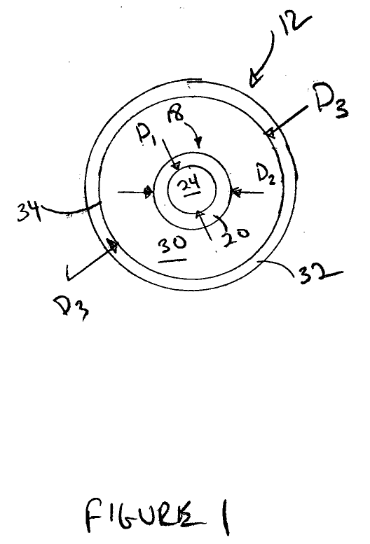

FIG. 1 is a cross section of one embodiment of an optical fiber 12 of the present invention. The optical fiber 12 comprises a core 18 that includes an outer region 20 disposed about the inner region 24, and a cladding 30 disposed about the core 18. The optical fiber 12 can include a region 32 disposed about the cladding 30. The region 32 can be a second cladding such that the cladding 30 can guide light, such as, for example, pump light for optically “pumping” an active material comprised by the optical fiber 12.

Stating herein that one region is “disposed about” about another region means that the one region surrounds, at least in part, the other region, and can, but need not, surround and/or contact the other region. Typically the cladding contacts and surrounds the outer region of the core 18 and a protective material or a second cladding contacts and surrounds the cladding. In some embodiments a selected material (e.g., a fluorinated acrylate polymer) can serve as protective material and as a second cladding.

Note that the inner region 24 of the core 18 can have a diameter D₁, the outer region 20 of the core 18 can have a diameter D₂ and the cladding 30 can have a diameter D₃.

A region, such as a cladding (e.g., the cladding 30 or the second cladding 32) or a region (e.g., one or both of the regions 20 and 24) of the core 18, need not have a constant index of refraction. It is known in the art to vary the index or refraction, such, for example, where the core of a fiber has a graded index, to provide a particular optical property. Thus for a region to “comprise an index of refraction” does not mean that the index of refraction is necessarily constant throughout the region. The use of “comprise” is exemplary, and any other open-ended term can be used instead of “comprise” (e.g., have, include, etc.).

The optical fiber 12 can have a flattened intensity profile, such as, for example, where the fundamental mode of the optical fiber 12 has a flattened intensity profile. Optical fibers (e.g., an optical fiber having a step index of refraction profile) typically have a fundamental mode having a substantially Gaussian intensity profile. It is known in the art to provide a fiber having an intensity profile that is “flattened” to reduce the highest intensity. See, for example, A. K. Ghatak, I. C. Goyal and Rajeev Jindal, “Design of Waveguide Refractive Index Profile to Obtain Flat Modal Field”, SPIE Vol. 3666, pp, 40-44 (“the Ghatak reference”), and Jay W. Dawson, Raymond Beach, Igor Javonovic, Benoit Wattellier, Steven Payne and C. P. J. Barty, “Large Flattened Mode Optical Fiber For High Output Energy Pulsed Fiber Lasers”, presented on Wednesday, Jun. 4, 2003 at CLEO, session code CWD5 (“the Dawson reference”). The Dawson reference describes an inner core surrounded by an outer core having an index of refraction that formed a “raised ring” relative to the inner core. The inner core is understood to comprise ytterbium-doped silica, while the outer core includes germanium rather than ytterbium to raise the index of refraction to provide the “raised ring”.

Both of the foregoing references (which are incorporated by reference herein to the extent necessary to understand the present invention and to the extent that they do not conflict with the teachings herein), teach how to design and/or give examples of an optical fiber having a flattened intensity profile. Often the flattened intensity profile can be substantially constant over a considerable portion of the diameter of the core of the fiber.

In one technique for flattening the intensity profile, the outer region 20 of the core 18 comprises a higher index of refraction than an index of refraction comprised by the inner region 24 of the core 18. The higher index of refraction comprised by the outer region 20 tends to draw light to the outer region 20, thereby flattening the intensity profile.

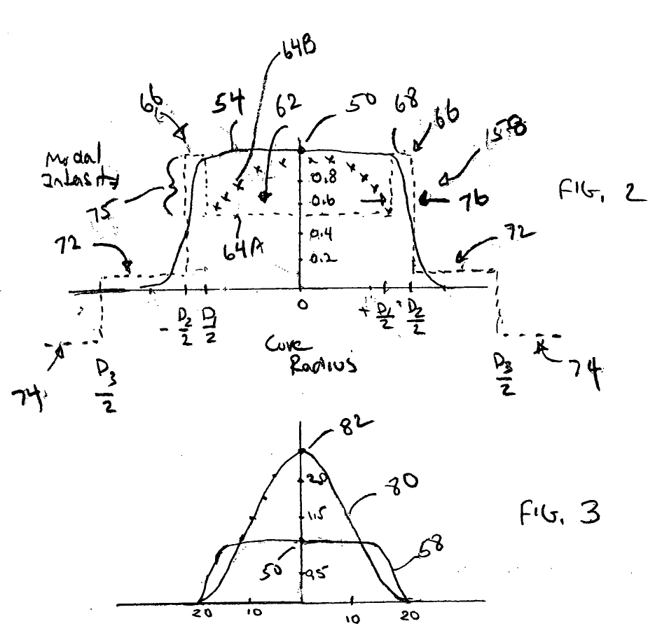

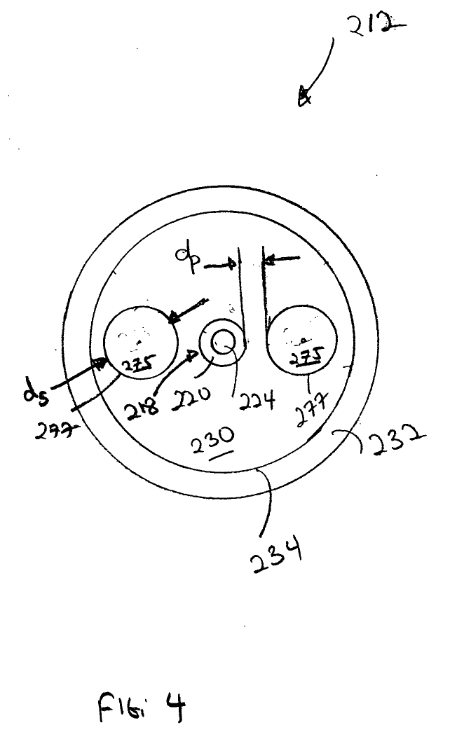

FIGS. 2 and 3 schematically illustrate possible refractive index and intensity profiles for the optical fiber 12 of FIG. 1. FIGS. 2 and 3 are based, at least in part, on the first two figures of the Dawson reference.

The vertical axis in FIG. 2 represents the intensity of the fundamental mode and is normalized to a value of 1 at its highest point, which can be the point 50. The horizontal axis corresponds to the radius of the core of the fiber 12 of FIG. 1, where the radii corresponding to D₁/2, D₂/2 and D₃/2 are marked. The curve 54 is the intensity profile for the fundamental mode of the fiber 12, and the dotted curve schematically illustrates one possible refractive index profile 58 for the optical fiber 12 of FIG. 1.

Note that the intensity profile for the fundamental mode is substantially constant (e.g., varies less than 20%) over a selected distance, such as, for example, the distance D₁ (i.e., from radius −D₁/2 to radius D₁/2). The modal intensity drops to 80% or less of its highest value for radii between D₁ and D₂. In other embodiments, the modal intensity varies less than 10% over a selected distance. The selected distance can represent more than 60%, or more than 70%, or more than 80% of an outside diameter (e.g., of D₂) of the core 18.

The refractive index profile 58 includes an inner section 62 having an index of refraction 64A. The inner section 62 corresponds generally to the inner region 24 of the core 18. The refractive index profile 58 also includes outer sections 66 that each have an index of refraction 68. The outer sections correspond generally to the outer region 20 of the core 18. The sections 72 can correspond to the cladding 30 and the sections 70 can correspond to the second cladding 32, if present.

The inner region 24 of the core 18 can have an index of refraction that is substantially constant as a function of radius such that refractive index profile 58 is substantially constant over the section 62, as shown in FIG. 2. Similarly, the outer region 20 of the core 18 can have an index of refraction that is substantially constant as a function of radius such that the refractive index profile 58 is substantially constant over the sections 66.

The sections 66 of the refractive index profile 58 each comprise an index of refraction 68 that is higher than the index of refraction comprised by the section 62 by a selected “delta”, as indicated by reference numeral 75. The sections 66 can each have a selected width, as indicated by reference numeral 76.

In one practice of the invention the inner region 24 comprises a graded index of refraction, where the index is highest at or near the center of the inner region 24 (ignoring any MCVD “center dip”) and decreases with increasing radial distance from the maximum. See FIG. 2, where the section 62 of refractive index profile 58 is optionally shown with the graded index profile 64B. The graded index profile 64B can have the shape of a parabola.

Note that if the fiber 12 is manufactured by the modified chemical vapor deposition (MCVD) process the index of refraction profile 58 can include the well-known “center dip” caused by the burnoff from the deposited core during collapse of a tube that becomes at least part of the preform from which an optical fiber can be drawn. Optical fibers of the present invention need not be made by MCVD, and other techniques, such as, for example, outside vapor deposition (OVD), can be used. Techniques are known for reducing the center dip and unless deliberately enhanced, the center dip is a minor artifact of one particular fabrication process, namely, MCVD, and hence is not shown as part of the index profile 58 of FIG. 2.

FIG. 3 is a comparison between the intensity profile 54 shown in FIG. 2 and a Gaussian profile 80 that is normalized to have the same total power as the intensity profile 54. Note that the highest intensity of the Gaussian profile 80, indicated by point 82, is approximately 2.5 times the highest intensity, indicated by reference numeral 50, of the intensity profile 54, which is quite flattened. Via appropriate selection of one or more of various parameters, such as the delta 75, the width 76 and the width of the section 62 (which is shown as substantially equal to D₁ in FIG. 2), the degree of flattening can be varied, as can be shown using the models noted in the Ghatak reference. The highest intensity of the intensity profile 54 can thus be, for example, no greater than 40%, no greater than 50%, no greater than 60%, no greater than 70%, no greater than 80%, or no greater than 90% of the highest intensity of a Gaussian normalized to have the same power (e.g., by doing an integration under each of the curves) as the intensity profile.

Applicants have discovered that an optical fiber having a flattened intensity profile can selectively include certain materials to raise the index of refraction in the outer region and/or to lower the index of refraction in the inner region to achieve a desired delta. The certain material can in many instances provide additional functionality to the optical fiber.

For example, the fiber 12 can comprise an active material, such as a selected rare earth. “Active material” means a material that can provide light having a first wavelength responsive to receiving light having a second wavelength (e.g., pump light) that is different than the first wavelength. An active material can include one or more rare earths. A rare earth or combination of rare earths can also act as a selective absorber that can absorb a selected wavelength or wavelengths. The rare earths are commonly understood to include elements from the periodic table having atomic numbers ranging from 57 to 71. Useful rare earths include ytterbium, erbium, neodymium, thulium and lanthanum. An optical fiber that includes both erbium and ytterbium is understood to be particularly useful. The region of the fiber that includes the erbium and ytterbium can also include phosphorus and alumimum.

According to one embodiment of the invention, one of the inner region 24 and the outer region 20 of the core 18 comprises a first concentration of a selected rare earth and any concentration of the selected rare earth comprised by the other of the regions is different (e.g., less, e.g., substantially less) than the first concentration. In one practice of the invention, the outer region 20 comprises the first concentration of the selected rare earth, and any concentration of the rare earth comprised by the inner region 24 is substantially less (e.g., the inner region is substantially free of the selected rare earth) than the first concentration. For one region to have “substantially less” of a selected rare earth than another region means that the concentration of the selected rare earth comprised by the one region no greater than 75% of the concentration of the selected rare earth comprised by the other region. In other practices of the invention, the concentration in the one region is no greater than 50%, no greater than 25%, or no greater than 10% of the concentration in the other region. “Substantially less” includes “substantially free”, and substantially free means that the one region includes only trace concentrations, if any concentration at all, of the selected rare earth.

Concentrations of rare earth refer to concentrations in ions per cubic centimeter, unless otherwise specified; concentrations of other materials refer to concentration in weight percent, unless otherwise specified, where the weight percent refers to the specific compound named (e.g., 10 weight percent B₂O₃), or if only an element is provided, to the weight percent of the compound that the element predominantly forms in the host material in question. For example, germanium predominantly forms GeO₂ in a silica glass host, and hence referring to a concentration of germanium means weight percent of GeO₂ (when the host is silica glass). It is not considered necessary to always specify the host when specifying a fiber according to the invention, as different hosts are possible (e.g., fluoride or phosphate glass hosts), and for a particular fiber a host is typically readily identifiable.

Because in certain embodiments the outer region 20 of the optical fiber “sees” significant power of the fundamental mode, the outer region can comprise the rare earth in a higher concentration than the inner region and the fiber can still provide acceptable performance in terms of, for example, stimulated emission. Certain drawbacks of a fiber wherein, for example, the entire core comprises the same concentration of the selected rare earth can be avoided, or the effects of such drawbacks reduced.

In certain fibers according to the invention, the cladding 30 can comprise an active material, such as, for example, one or more rare earths. For example, with reference to FIG. 2, the active material can be located at radii greater than D₂/2 (and less than −D₂/2). The active material need not, in all cases, extend throughout the cladding, meaning that the concentration of the rare earth can be essentially zero for radii having an absolute value that is greater than a selected value that is greater than D₂/2 but less than D₃/2 (e.g., one half of D₃/2-D₂/2). The cladding 30 can comprise a selected rare earth and the inner region 24 of the core 18, or the outer region 20 of the core 18, or both, can comprise a concentration of the selected rare earth that is less than the concentration comprised by the cladding 30. For example, the cladding 30 and outer region 20 of the core 18 can comprise the selected rare earth and the inner region 24 of the core 18 can be substantially free of the selected rare earth.

Fibers having a flattened intensity profile and a rare earth can be useful in optical devices such as, for example, lasers, amplifiers, amplified spontaneous emission (ASE) sources and superfluorescent sources. Such devices often include reflectors, which in some instances can be fiber gratings (e.g., short period or long period gratings) written via exposing a length of the fiber to a selected pattern of actinic radiation, provided that the length of fiber is sufficiently photosensitive (i.e., can have an index of refraction changed via exposure to the actinic radiation).

In one practice of the invention, one region (e.g., the outer region 20) comprises a selected concentration of a selected photosensitive material (e.g., germanium, tin, etc.) and a concentration of the selected photosensitive material comprised by the other region (e.g., the inner region 24) is different (e.g., less, e.g., substantially less) than the selected concentration. For one region to have a concentration of a photosensitive material that is substantially less than the first concentration means that the concentration of the photosensitive material comprised by the one region is no greater than 75% of the first concentration (where the concentrations are expressed in weight percent). In various embodiments of the invention any concentration of the photosensitive material in the region is no greater than 50% of the first concentration; no greater than 25% of the first concentration; or no greater than 10% of the first concentration. “Substantially less” includes “substantially free”, where substantially free means that no concentration greater than that of a trace amount is present.

In yet another embodiment of the invention one region (e.g., the inner region 24) comprises a concentration of a selected rare earth that is higher than the concentration of the selected rare earth comprised by the other region (e.g., the outer region 20), and the other region (e.g., the outer region 20) comprises a concentration of a selected photosensitive material that is higher than the concentration of the selected photosensitive material comprised by the one region (e.g., the inner region 24). As a more specific example, the inner region 24 can comprise a silica based glass as well as the selected rare earth(s), which can comprise, for example, erbium or ytterbium. It can be advantageous to dope a fiber region with both erbium and ytterbium. The outer region 20 can comprise the selected photosensitive material, such as, for example, germanium (typically predominantly in the form of GeO₂ and including some accompanying GeO). The inner region 24 can have a lesser concentration of GeO₂ than the outer region 20 (e.g., can be substantially free of germanium) and the outer region 20 can be substantially free of the selected rare earth(s), meaning, for example, that it is substantially free of at least one of the erbium or ytterbium. Such a design can avoid devitrification problems that can arise when germanium, erbium and ytterbium are doped into the same region of a silica glass host, especially when phosphorus is included with the erbium and ytterbium to increase pumping efficiency, yet can allow a grating to effectively operate (e.g., pass or block light) at a wavelength at which the erbium and ytterbium can provide light (e.g., about 1150 nm). Useful pump wavelengths include about 915 nanometers and about 975 nanometers.

Note when the inner region 24 of core and the outer region 20 of the core 18 both include germanium, and one of the regions (e.g., the inner region 20) includes erbium, ytterbium and phosphorus and possibly aluminum, it can be advantageous to include a thin buffer region between the inner region 24 and the outer region 20, where the thin buffer region includes germanium and phosphorus. This can help avoid issues with devitrification.

A region of the fiber (e.g., the inner region 24 or the outer region 20) can include one or more of from 10% to 25% percent by weight P₂O₅; from 0.7% to 3.5% by weight of ytterbium (Yb₂0₃); and from 0% to 0.5% by weight of Er₂O₃.

An optical fiber according to the invention can have a wavelength of operation, such as, for example, the first wavelength at which a rare earth provides light responsive to being pumped by light having a different wavelength than the first wavelength. In one embodiment a fiber according to the invention is single mode at the wavelength of operation. In another embodiment, the core of the optical fiber can support, or propagate, two or more modes at the operating wavelength, and in a further embodiment, an optical fiber according to the invention can support, or propagate, five or more modes at the operating wavelength.

A Gaussian distribution for the electrical field of a light beam has the form E(r)=E(0)exp[−(r/w)²], where r is the distance from the center of the light beam and w is the radius at which the amplitude of the beam falls to 1/e of its maximum value of E(0). Power is proportional to the square of the electric field, and so the intensity function is proportional to E(0)exp[−2(r/w)²], which is also a Gaussian distribution. An intensity profile for a beam of light can be measured, such as by suitable near field techniques, as is known in the art.

Mode field diameter can be defined as the diameter where at the ends of the diameter the amplitude has fallen to 1/e of the maximum value. From the definition above, the Gaussian beam includes a mode field diameter of 2W. The power in a light beam is proportional to the square of the electric field, and so for an intensity profile w corresponds to the radius wherein the power falls to 1/e² of its highest value. A diameter between 1/e² points can define a MFD. A beam can have different MFDs across different diameters.

According to various embodiments, an optical fiber according to the invention can have a MFD of at least 15 microns, at least 20 microns, at least 25 microns, about 25 microns, at least 30 microns, or at least 50 microns. In some practices of the invention, the foregoing MFDs are for the fundamental mode; in other practices of the invention, the foregoing MFDs correspond to the MFD of a fiber that supports more than one mode.

In one practice of the invention, the diameter of the inner region, D₁, can be at least 3.5 times a thickness of the outer region of the core, or, in other terms, D₁ can be at least 3.5×(D₂−D₁).

The optical fiber 12 can also include, in some embodiments, a second cladding 32 disposed about the cladding 30. The second cladding 32 can comprise an index of refraction that is less than an index of refraction comprise by the cladding 30 such that the cladding 30 can guide light, such as, for example, “pump” light to be received by an active material. The cladding 30 has an outer perimeter 34 that is shown as substantially circular in FIG. 1.

The second cladding can include an acrylate polymer having a sufficiently low index of refraction, such as, for example, a fluorinated acrylate polymer. Claddings using such polymers are known to those of ordinary skill in the art and are commercially available. The second cladding can also include a glass, such as a silica based glass. The silica glass can be doped to reduce the index of refraction of the glass. Dopants known to reduce the index of refraction of silica glass include fluorine and boron.

In certain practices of the invention, the diameter D₃ can be no less than 100 microns, no less than 200 microns, no less than 300 microns, no less than 400 microns, or no less than 500 microns. In other practices, the diameter D₃ can be from 100 to 300 microns, from 300 to 500 microns, or from 100 to 500 microns. Larger values for D₃ can be particularly useful when the optical fiber 12 includes the second cladding 32 such that the cladding 30 can guide pump light.

Certain techniques can be employed to promote mode mixing of pump light (e.g., scatter skew rays) and thus help ensure that pump light is efficiently directed to the active material, such as, for example, when the core of the fiber comprises the active material. The core of the optical fiber can be located off center relative to the geometric center of the outer perimeter of the inner cladding. The outer perimeter can be shaped such that the inner cladding has two perpendicular diameters having different lengths. The outer perimeter can have a shape, such as a polygonal shape (e.g., a triangle), that tiles a plane. The outer perimeter can include longitudinally extending troughs, which can give the outer perimeter a “star” shape. The outer perimeter can have at least one flat section, such that the outer perimeter has a “D” shape, or the outer perimeter can have alternating straight sections and inwardly curved sections, or the outer perimeter can include circularly shaped irregularities. The outer perimeter can be shaped as an octagon or a cross, and can include longitudinally extending features (e.g., voids) to provide the inner cladding with a low effective index of refraction. The inner cladding can include truncated or longitudinally extending scattering regions that have a different index of refraction than the surrounding inner cladding. The fiber can be twisted during draw.

Certain patents disclose some of the foregoing techniques. See, for example, the following U.S. patents: U.S. Pat. No. 4,815,079, issued to Snitzer et al. and entitled “Optical Fiber Lasers and Amplifiers”; U.S. Pat. No. 5,533,163, issued to Muendel and entitled “Optical Fiber Structure for Efficient Use of Pump Power”; U.S. Pat. No. 5,864,645, issued to Zellmer et al. and entitled “Double-Core Light-Conducting Fiber, Process for Producing the Same, Double-Core Fiber Laser, and Double-Core Fiber Amplifier”; U.S. Pat. No. 5,873,923, issued to DiGiovanni and entitled “Method of Making a Cladding Pumped Fiber Structure”; U.S. Pat. No. 5,949,941 issued to DiGiovanni and entitled “Cladding-Pumped Fiber Structures”; U.S. Pat. No. 5,966,491, issued to DiGiovanni and entitled “Cladding-Pumped Fiber Structure”; U.S. Pat. No. 6,115,526, issued to Morse and entitled “Ultra High Numerical Aperture High Power Optical Fiber Laser”; U.S. Pat. No. 6,157,763, issued to Grubb et al. and entitled “Double-Clad Optical Fiber With Improved Inner Cladding Geometry”; and WO 99/30391, in the name of Anthon et al., and entitled “Double-Clad Rare Earth Doped Optical Fibers”. See also U.S. Pat. No. 6,477,307, entitled “Cladding Pumped Optical Fiber and Methods for Fabricating”, issued to Tankala et al.; U.S. Pat. No. 6,483,973, entitled “Cladding Member for Optical Fibers and Optical Fibers Formed with the Cladding Member”, issued to Mazzarese et al.; and U.S. Pat. No. 6,411,762, entitled “Optical Fiber with Irregularities at Cladding Boundary”, issued Jun. 25, 2002 to Anthon et al.

The optical fibers 12, 212, 312 and 412 (FIGS. 1, 4, 5 and 6) can each also include one or more protective coatings, such as acrylate polymer coatings, disposed about the fibers. Such protective coatings are well known in the art. Often two protective coatings are applied via nested cups on a draw tower, where the inner coating is softer than the outer coating. Often such coatings can be cured to a selected degree via exposure of the fiber to suitable actinic (e.g., ultraviolet) radiation. In certain practices of the invention the second cladding can comprise at least one of the coatings, which can be, for example, a fluorinated acrylate polymer having a suitably low index of refraction.

Certain photosensitive materials can provide a change in the index of refraction of as much as 1% responsive to exposure to actinic radiation. Hydrogen loading may be required in some instances to realize such a change. More commonly, in a silica based glass, an absolute change in the index of refraction from about 1-3×10⁻⁴ to up to 5×10⁻³ can be realized upon exposure under appropriate conditions to actinic radiation. Actinic radiation having a wavelength of about 193 nm or of about 244 nm is typically used with silica glass doped with germanium.

The photosensitivity of a fiber or a region of fiber can be characterized by the amount of photosensitive material comprised by the fiber or region or by the change in the index of refraction of the region responsive to exposure to actinic radiation.

As used herein, for one region to be substantially more photosensitive than another region means that the change in index in the other region (under substantially identical writing conditions of exposure to actinic radiation) is no greater than 75% of the change in index in the one region. In other embodiments of the invention the change in the another region is no greater than 50%, or no greater than 25%, of the change in the one region.

The change in refractive index of the two regions of a fiber is to be determined responsive to exposing a selected length of the optical fiber to actinic radiation. For example, the selected length can be exposed while refraining from exposing a different length of the same fiber to the actinic radiation. The refractive index profiles of each of the lengths of the fiber can be compared to see the change in refractive index of each of the regions relative to the unexposed length due to the photosensitive nature of the region. (Although the inner region may be shielded to some extent by the outer region from the actinic radiation, this is typically the case when writing gratings and no compensation is made.) If a first region has less than 50% of the photosensitivity of a second region, then the change in index in the first region (e.g., 0.0001) should be less than half of the change in the second region (e.g., which should be greater than 0.0002).

If either of the regions includes germanium the test should be done using actinic radiation having a wavelength of 193 nanometers and inducing Type II behavior in either region as well as hydrogen loading prior to exposure are to be avoided. Test conditions can be reasonably arranged to achieve the maximum change in the region having the higher photosensitivity, subject to the foregoing qualifications. If neither of the regions comprises germanium, then the foregoing criterion can be used to establish the wavelength as well as other test conditions.

Various materials, such as germanium, are known to be photosensitive. A region having a selected photosensitivity can comprise silicon dioxide (SiO₂) doped with a concentration of germanium in the form of GeO₂ of at least 7.0% by weight. Ranges of a concentration of GeO₂ from 7% to 40% by weight and from 7% to 20% by weight are also within the scope of the invention.

To enhance the photosensitivity of a region of the fiber, it can be desirable to incorporate as much of a selected photosensitive material (e.g., germanium) as possible into the region of the fiber that is to be rendered photosensitive. Many materials, such as germanium, raise the index of refraction, and a large concentration, desirable for photosensitivity, may raise the index of refraction such that it may be detrimental in certain circumstances. For example, it may be desired to maintain the delta 75 of FIG. 2 within a certain range. Accordingly, in one practice of the invention, a material is added that has the opposite effect (e.g., decreases) on the index of refraction, such that more of the photosensitive material, such as germanium, may be added. Boron and fluorine both typically decrease the index of refraction of a host material.

In one practice of the invention a region of the fiber includes a photosensitive material and fluorine, such as, for example, germanium (e.g., in the form of GeO₂) and fluorine. In one practice of the invention, a fiber can comprise a region having a concentration of germanium in the form of GeO₂ ranging from 10.0% to 40.0% by weight and a concentration of fluorine ranging from 0.1% to 5.0% by weight. In another practice of the invention, the concentration of germanium in the form of GeO₂ ranges from 10.0% to 20.0% by weight and the concentration of fluorine ranges from 0.2% to 3.0% by weight. Preferably, silicon dioxide (SiO₂) comprises the remainder weight %. Fiber wherein the photosensitive region, such as, for example, the core of the fiber, comprises greater than 6% by weight of GeO₂ can be useful.

Boron can enhance photosensitivity in addition to reducing the index of refraction. In one practice of the invention, a region of the fiber can include a concentration of germanium of at least 7% by mole and a concentration of boron of at least 1% by mole. In another practice of the invention, an optical fiber according to the invention can include a region that comprises a concentration of GeO₂ from 7% by mole to 40% by mole. Independent of or in addition to the foregoing, the region can include a concentration of boron from 1% by mole to 12% by mole. A region of an optical fiber can comprise a concentration of GeO₂ from 10% by mole to 30% by mole. Independent of or in addition to the foregoing, the region can include a concentration of B₂O₃ from 2% by mole to 12% by mole. A region of an optical fiber can comprise a concentration of GeO₂ from 15% by mole to 25% by mole and, independent of or in addition to the foregoing, a concentration of B₂O₃ from 3% by mole to 8% by mole.

The foregoing examples using silica, germanium, fluorine and boron are exemplary. A fiber according to the invention can include glasses other than silica, and may even comprise other materials, such as polymers.

A fiber according to the invention can include the concentrations noted herein in a SiO₂ host glass. Most preferably, a region of a core or cladding according to the invention consists of a silica host glass and the materials and concentrations specified, i.e., the fiber core or cladding consists of silica and these dopants exclusively. In many instances certain amounts of other materials may also be included in the makeup of the core or the cladding, but at levels that do not affect the fundamental properties of the fiber presented herein. These amounts have been omitted from discussion above and may be considered to be part of the remainder mole percentage typically attributed to the host glass, such as silicon dioxide (SiO₂), such that a fiber according to the invention consists essentially of the materials in the concentrations noted above. As can be seen from the discussion above, a fiber according to the invention can include a photosensitive region, such as a region of the core of the fiber, that is greater or equal to approximately 50% by mole of silica glass and that includes boron. The photosensitive region can be made up of at least 80% by mole of silica glass.

As can be seen from the discussion above, a fiber according to the invention can include a photosensitive region, such as a region of the core of the fiber, which comprises greater or equal to approximately 75% by weight of silica glass. The photosensitive region can comprise at least 80% by weight of silica glass.

Note that the phenomenon of photosensitivity is not very well understood. Incorporating germanium into a fiber, and in particular into a glass fiber, is understood to be one way to provide photosensitivity, especially when the germanium is incorporated as GeO₂ in a silica fiber. It has been noted that some small amount of GeO tends to accompany the GeO₂, and that the photosensitivity of a fiber may be related to this concentration of GeO. As is known in the art (see, for example, U.S. Pat. No. 5,157,747) some researchers consider that collapsing a preform in a reducing atmosphere can increase the amount of GeO in the resultant fiber drawn from the preform and thus enhance the photosensitivity of the fiber.

The range of wavelengths at which fiber lasers and amplifiers can efficiently operate can be limited compared to other types of lasers and amplifiers. It can be desirable to convert light from a fiber device to another more useftil wavelength.

Processes are known for converting light at one of the wavelengths available from fiber devices to light at a more desirable wavelength. Some of the processes for converting light to another wavelength, such as launching light onto a phase matched crystal, can require that the light to be converted have a known linear polarization. Light is an electromagnetic wave in which the electric field can oscillate along a direction that is perpendicular to the direction in which the light propagates. For example, if the electric field vibrates along the horizontal axis, the light is said to be horizontally polarized; if the light vibrates along the vertical axis, the light is said to be vertically polarized. Most fiber propagates light in two orthogonal polarizations (i.e., both vertical and horizontal) which couple back and forth as the light propagates along the fiber, such that the polarization of the light emanating from the fiber is a mixture of both vertical and horizontal polarizations and is thus not controlled. Proper control of the polarization can provide more efficient wavelength conversion. When unpolarized light is provided to the crystal, the component of the light that is polarized in the wrong direction is simply is not converted and is wasted. Avoiding this waste means that the light provided to the crystal have the proper polarization.

In one practice of the invention, a fiber can include a selected birefringence, such as, for example, a selected birefringence at the wavelength of operation of the fiber. Birefringence can help to provide an optical fiber with polarization maintaining or polarizing properties, which can be useful in a variety of practical applications. For example, coupling between orthogonal linear polarizations is inevitable in a practical fiber. Providing a fiber with sufficient birefringence, such that the light in one of the polarizations has a different phase velocity and/or wavelength than light in the other of the polarizations, can reduce any constructive superposition of light undesirably coupled into one linear polarization from the orthogonal (and desired) polarization at various locations along the length of a fiber.

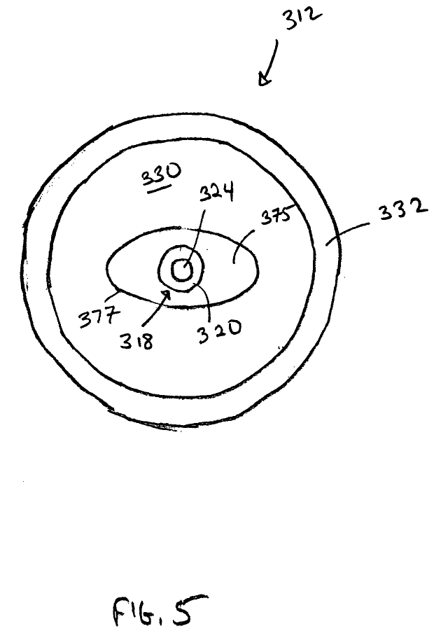

FIG. 4 illustrates an additional embodiment wherein an optical fiber, such as the optical fiber 12 of FIG. 1, includes longitudinally extending regions for inducing stress in all or part of a selected region of the optical fiber. The optical fiber 212 includes a core 218 having an outer region 220 disposed about an inner region 224. The fiber 212 includes a cladding 230 disposed about the core and a second cladding 232 disposed about the cladding 230. The fiber 212 includes a pair of longitudinally extending regions 275. The fiber shown in FIGURE is a “Panda” style fiber in that each of the regions 275 has a substantially circular outer perimeter 277. The longitudinally extending regions 275 can each have a thermal coefficient of expansion (TCE) that is different than the TCE of the region of the fiber that is disposed about the longitudinally extending region, such as, for example, the cladding 230. Because the TCEs of the regions 275 and the cladding 230 are different, a stress is induced in all or part of a region of the fiber, such as, for example, the core 218, when the fiber cools after being drawn, such as when being drawn from a heated preform. The stress can introduce a selected birefringence (i.e., different refractive indices for the orthogonal linear polarizations) due to the stress-optic effect.

The birefringence is a function at least of the diameter dₛ of the regions 275, the proximity dₚ of the longitudinally extending regions 275 for inducing stress to the core 218, and the difference between the TCE of each of the longitudinally extending regions 275 and the TCE of the regions of the fiber surrounding longitudinally extending regions 275 such as, for example, the TCE of the inner cladding 230. Increasing the diameter dₛ, decreasing the spacing between the longitudinally extending regions 275 and the core 218, dₚ, and increasing the difference between the TCE of the longitudinally extending regions 275 and the TCE of the inner cladding 230 all increase the birefringence, as well as the stress induced in the core 218. As is well understood by one of ordinary skill in the art, the longitudinally extending regions typically comprise one or both of boron and phosphorous, typically in the form of one or more of B₂O₃, P₂O₅, or BPO₄, although other dopants can be used, such as, for example, germanium, aluminum and titanium, to help provide a desired TCE. The foregoing materials can be used alone or in combination. Such materials can help provide a TCE that is different than the TCE of the cladding or other region of the fiber that surrounds the longitudinally extending regions. For example, increasing the amount of boron and/or phosphorus comprised by the longitudinally extending regions typically increases the birefringence of the optical fiber.

Because phosphorus and boron have opposite effects on the index of refraction of a host glass, such as a host glass that comprises silica, the longitudinally extending regions 275 can comprise an index of refraction that can be selected independently of the TCE of the stress inducing region. Although Applicants consider that the stress induced in the cladding by the longitudinally extending regions 275 contributes more than appreciated previously to the scattering of the pump light, it can also be advantageous in promoting scattering to maintain a sufficiently large difference between the indices of refraction comprised by the longitudinally extending regions 275 and the index of refraction comprised by the inner cladding 230. Preferably, the longitudinally extending regions 275 have an index of refraction that is lower than the index of refraction of the inner cladding 230 such that the longitudinally extending regions 275 do not act as cores that can guide light. Suitable index differences between one or both of the longitudinally extending regions 275 and the inner cladding 230 can range from 0.005 to 0.015. One typical index difference found to be useful is about 0.01.

Longitudinally extending regions for inducing stress are well known in the art and the proper composition for achieving the particular TCE and hence inducing a particular stress in the fiber are also well known and only briefly discussed here. See, for example, the thesis of Bent Edvold entitled “Polarization Maintaining Fibers”, Electromagnetics Institute, Technical University of Denmark, EF-402, April, 1994. Tankala et al. have described in detail the theoretical, geometrical and manufacturing considerations for providing a fiber with birefringence, particularly with reference to polarization maintaining double clad fibers (see for example K. Tankala, A. Carter, D. P. Machewirth, J. Farroni, J. Abramczyk and U. H. Manyam, SPIE proc v. 4974, p 220, 2003, incorporated herein by reference). The foregoing are incorporated by reference to the extent necessary to understand the present invention and to the extent that they do not contradict the teachings herein. See also patents relating to polarization maintaining fibers, such as, for example, patents from Corning Glass Works of Corning, N.Y., which is well known for developing fibers designed to have selected birefringence and hence be polarization maintaining or polarizing.

More particularly, see U.S. Pat. No. 4,395,270, entitled “Method of Fabricating a Polarization Retaining Single-Mode Optical Waveguide”, filed Apr. 13, 1981 and issued Jul. 26, 1983 to Blankenship and Keck. See also U.S. Pat. No. 4,478,489, entitled “Polarization Retaining Single-Mode Optical Waveguide”, filed Mar. 28, 1983 and issued Oct. 23, 1984 to Blankenship and Keck, as well as U.S. Pat. No. 4,561,871, entitled “Method of Making Polarization Preserving Optical Fiber”, filed Dec. 27, 1983 and issued Dec. 31, 1985 to Berkey. In addition, see U.S. Pat. No. 5,152,818, entitled “Method of Making Polarization Retaining Fiber”, filed Nov. 9, 1990 and issued Oct. 6, 1992 to Berkey, Bhagavatula, Hawk and Tarcza. See in addition U.S. Pat. No. 4,896,942, entitled “Polarization-Maintaining Optical Fiber”, filed Feb. 3, 1989 and issued Jan. 30, 1990 to Onstott, Messerly, Mikkelson and Donalds. Publications include G.B. Patent Application 2,012,983 A, entitled “Optical Waveguides Having Non-Uniform Outer Jackets”, published Aug. 1, 1979 in the names of Kaminow, Pleibel, Ramaswamy and Stolen; Hosaka et al., Electronics Letters, 17, 191 (1981); Hosaka et al., Electronics Letters, 17, 631 (1981); and D. Kliner et al., Optics Letters 26, 184 (2001). The foregoing are incorporated by reference to the extent necessary to understand the present invention and to the extent that they do not contradict the teachings herein.

As noted above, polarization maintaining fibers typically use birefringence to reduce the effect (e.g., constructive superposition) of any coupling between orthogonal linear polarizations. Typically, this means that a PM fiber is designed to have as high a birefringence as possible. Fibers having increased birefringence are typically one or more of more expensive and more difficult to manufacture than fibers having lower birefringence. However, coupling between polarizations can be reduced such that increased birefringence is supposedly not as necessary. See published U.S. patent application US 2002/0172486 A1, which indicates that the diameter of an optical fiber can be selected to reduce coupling between polarizations.

A polarizing fiber can also use birefringence. For example, in one approach, birefringence is introduced into both the core and the cladding, with the core having a higher birefringence than the cladding, and such that one of the polarizations has a larger mode field diameter and is sufficiently more susceptible to bend loss. In another approach, the index of the core and cladding are equal for one of the polarizations, such that the one polarization is not guided. In another approach, the birefringence of the core and cladding are equal, but the mode for one of the polarizations is “leaky” because it has a small component along the direction of the other polarization which sees loss, as the fiber is designed such that the effective index for the one polarization is lower than the index of refraction for the other polarization. In yet a further approach, a polarizing fiber can include absorptive stress inducing regions. In an additional approach, a “W” shaped refractive index profile allows one of the polarizations to “tunnel” through the “well” of the “W” and sees the higher index of the cladding outside the well. Other approaches include providing a metal film on one side or on opposing sides of the optical fiber (to selectively attenuate one polarization) or providing a metal cladding over the fiber. Typically, a polarizing fiber includes a window of wavelengths, such as, for example a window of 20 nm or 100 nm, wherein one polarization has high loss and the other polarization has lower, and hopefully, acceptable, loss for the application in which the polarizing fiber is to be used.

Various approaches are described in the following publications and patents that are understood to address polarizing fibers: J. R. Simson et al., Journal of Lightwave Technology, 1, 370 (1983); K. Okamato, Applied Optics 23, 2638 (1984); Kin Seng Chang, Journal of Lightwave Technology, 7, 436 (1989); Michael J. Messerly et al., Journal of Lightwave Technology, 9, 817 (1991); Frank F. Ruhl and Danny Wong, Optics Letters, Vol. 14, 648 (1989); M. P. Varnham et al., Electronics Letters, 19, 246 (1983); M. P. Varnham et al., Optics Letters 9, 306 (1984); K. Okamoto, Applied Optics 23, 2638 (1984); K. Okamoto, Journal of Lightwave Technology 3, 758 (1985); W. Eickhoff, Optics Letters 7, 629 (1982); A. W. Snyder and F. Ruhl, Journal Optical Society of America, 73, 1165 (1983); R. H. Stolen et al., Electronics Letters, 24, 524 (1988); K. Tajima et al., Journal of Lightwave Technology, 7, 1499 (1982); K. S. Chiang, Journal of Lightwave Technology, 7, 436 (1989); W. Eickhoff, Electronics Letters, 16, 762 (1980); P. Kornreich et al., Proceedings of the SPIE 2749, 11 (1996); T. Hosaka et al., Optics Letters 8, 124 (1983); T. Hosaka et al., Journal of Quantum Electronics, 18, 1569 (1982); R. A. Bergh et al., Optics Letters 5, 479 (1980). The foregoing are incorporated by reference to the extent necessary to understand the present invention and to the extent that they do not contradict the teachings herein.

See also the following U.S. patents: U.S. Pat. No. 4,515,436, entitled “Single-Mode Single Polarization Optical Fiber”, filed Feb. 4, 1983 and issued May 7, 1985 to Howard, Pleibel, Simson, and Stolen; and U.S. Pat. No. 5,056,888, entitled “Single-Mode, Single-Polarization Optical Fiber”, filed Jul. 17, 1989 and issued Oct. 15, 1991 to Messerly, Onstott and Mikkelson. The foregoing are incorporated by reference to the extent necessary to practice the present invention and to the extent that they do not contradict the teachings herein.

In a fiber demonstrating polarization maintaining behavior, the attenuation of each of the polarizations is usually nearly the same at a wavelength of interest. For example, in one aspect of invention, the lower attenuation of the two polarizations (e.g., the lower of the attenuations of the fast and slow polarizations of the fundamental mode) is no less than the higher attenuation minus a certain percentage, in dB, of the higher attenuation (e.g., 10%, 15%, or 20%). For example, if the higher attenuation were 1 dB, the lower attenuation should be no less than 0.9 dB if 10% is specified.

Alone or in combination with the foregoing percentage specification, for polarization maintaining behavior the attenuation of two polarizations (e.g., the fast and slow polarizations of the fundamental mode) will typically be no greater than a particular amount, such as, for example, no greater than 1, no greater than 2, no greater than 3, no greater than 4, no greater than 5, no greater than 6, no greater than 7, no greater than 8 or no greater than 9 dB.

In a fiber demonstrating polarizing behavior, the attenuation of one polarization (e.g., attenuation due to bend loss) exceeds that of the other polarization by a specified amount, such as, for example, at least 0.5 dB, as least 1 dB, at least 2 dB, at least 3 dB, at least 6 dB, at least 9 dB, at least 12 dB, at least 15 dB, at least 18 dB, at least 20 dB or greater than 20 dB at a wavelength of interest. In conjunction with the foregoing, it can be further specified that the attenuation of one of the polarizations is less than or no greater than a specified amount, such as, for example, no greater than 1 dB, no greater than 3 dB, no greater than 5 dB, no greater than 7 dB, no greater than 9 dB, or no greater than 11 dB.

The fiber can have a bandwidth, where bandwidth can be defined by specifying a wavelength range (e.g., 10 nm, 20 nm, 30 nm, 40 nm, 50 nm, 60 nm, 70 nm, 80 nm, 90 nm, 100 nm or greater than 100 nanometers) over which the attenuation definitions are met.

The attenuations noted for polarization maintaining and polarizing behavior can be attenuation due only to bend loss or can refer to total attenuation (e.g., bend loss or bend loss and other sources of attenuation, such as background loss) and can be specified per unit length, such as, for example, per meter, per the length of fiber used in a particular apparatus (which can typically range from less than a meter to 20 or 30 meters), or per kilometer (per kilometer would apply where a fiber includes little or no rare earth). Each is within the scope of the present invention.

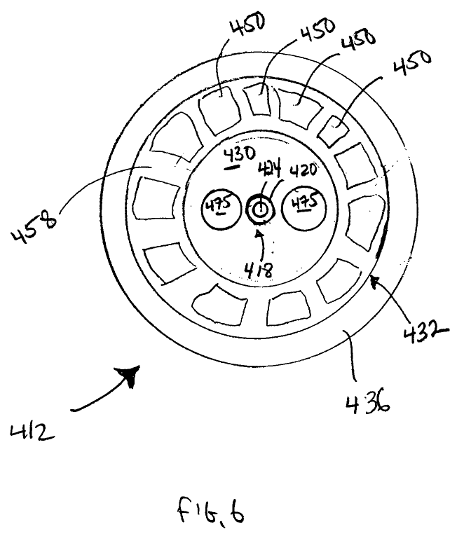

FIG. 5 illustrates a further embodiment of the present invention wherein an optical fiber 312 includes a core 318 having an outer region 320 disposed about an inner region 324, a cladding 330 disposed about the core 318. The cladding has a first TCE, and the fiber 312 includes a longitudinally extending region 375 having a TCE that is different than the first TCE of the cladding 330. Stress is induced in part or all of one or more regions of the fiber 312 for providing a selected birefringence. The region 375 can include a noncircular perimeter 377, such as, for example, the ellipse shown in FIG. 5. The fiber 312 can include a second cladding 332 disposed about the cladding 330. In certain embodiments it can be advantageous that the fiber 312 include a region that acts as a barrier between the longitudinally extending region 375 and one or both of the regions 320 and 324 of the core 318. See, for example, U.S. Pat. No. 4,896,942, entitled “Polarization-Maintaining Optical Fiber”, filed Feb. 3, 1989 and issued Jan. 30, 1990 to Onstott, Messerly, Mikkelson and Donalds. The '942 patent is incorporated herein by reference to the extent necessary to practice the present invention and to the extent that it does contradict the teachings herein. A region that acts as barrier region can also be disposed about the longitudinally extending region 375. The region 320 could act as the barrier in certain embodiments.

FIG. 6 illustrates a cross section of yet another embodiment of an optical fiber 412 according to the invention. The optical fiber 412 comprises a core 418 having an outer region 420 disposed about an inner region 424, as discussed above. The cladding 430 is disposed about the core 418 and has a first TCE. The fiber includes at least one (e.g., a pair) longitudinally extending region(s) 475 that have a TCE that is different than the first TCE of the cladding. The TCEs of the regions 475 can be different, though typically they are substantially the same.

The second cladding can 432 can include longitudinally extending features 450 (e.g., can be microstructured) that have a different index of refraction than the material 458 that is adjacent the features 450 so as to provide a selected effective index of refraction for the second cladding 432. The effective index of refraction can be quite low and can help provide a larger NA for the cladding 430 (e.g., at least 0.5; at least 0.6, or at least 0.7). The features 450 can include voids that include a gas (e.g., air) or are evacuated, or that include a liquid or solid having a different index of refraction (e.g., lower) than the material 458 that is adjacent the features. In one practice the second cladding 432 can have an effective index of 1.35 or less. The second cladding 432 can be formed from a preform that includes a plurality of glass tubes, such as, for example, silica based tubes inside a larger silica based tube. The larger tube can form the outer region 436 of the optical fiber 412. See, for example, U.S. Pat. No. 5,907,652, entitled “Article Comprising An Air-Clad Optical Fiber”, issued May 25, 1999. See also U.S. Pat. No. 6,115,526, entitled “Ultra High Numerical Aperture High Power Optical Fiber Laser”, issued Sep. 5, 2000, where the second cladding comprises a gas. The first cladding can be microstructured and/or comprise a gas, as described above, particularly when the fiber is not double clad and/or when the core of the fiber receives pump light directly (e.g., the fiber is end pumped). The '652 and '526 patents are herein incorporated by reference to the extent necessary to understand the present invention, and to the extent that they do not contradict the teachings herein.

The amount of birefringence found to be adequate can depend on the tendency of a particular fiber to couple energy between the fast and slow polarizations, such that good polarization maintaining characteristics can allegedly be obtained for lower values of birefringence (see the aforementioned U.S. Published patent application US 2002/0172486 A1).

The birefringence of a fiber according to the present invention (typically a fiber demonstrating polarization maintaining behavior) can be no less than 1×10⁻⁴; no less than 1.5×10⁻⁴; no less than 2×10⁻⁴; no less than 2.5×10⁻⁴; no less than 3×10⁻⁴; no less than 3.5×10⁻⁴; no less than 4×10⁻⁴; no less than 4.5×10⁻⁴; no less than 5×10⁻⁴; or no less than 6×10⁻⁴. Alternatively, the birefringence can be no greater than 1×10⁻⁴; no greater than 1.5×10⁻⁴; no greater than 2×10⁻⁴; no greater than 2.5×10⁻⁴; no greater than 3×10⁻⁴; no greater than 3.5×10⁻⁴; no greater than 4×10⁻⁴; no greater than 4.5×10⁻⁴; no greater than 5×10⁻⁴; no greater than 5.5×10⁻⁴; or no greater than 6×10⁻⁴. The birefringence can be from 1×10⁻⁴ to 6×10⁻⁴, or from 1×10⁻⁴ to 3×10⁻⁴, or from 3×10⁻⁴ to 6×10⁻⁴, or from 2×10⁻⁴ to 5×10−4. The birefringence of a fiber can be measured by techniques known in the art.

Birefringence is related to beat length by the following formula:
Beat length=(free space wavelength)/(birefringence)
Where the birefringence refers to the difference in refractive index for orthogonal polarizations of light (e.g., difference between refractive indices for slow axis and fast axis polarizations).

Ranges of useful beat lengths (beat lengths are for 633 nm) are as follows: in one practice of the invention, the beat length is no less than 0.5 mm; no less than 0.75 mm; no less than 1 mm; greater than 1 mm; no less than 1.25 mm; no less than 1.5 mm; no less than 2 mm; no less than 2.5 mm; no less than 3 mm; and no less than 5 mm. Beat lengths can also be no greater than 0.5 mm; no greater than 0.75 mm; no greater than 1 mm; no greater than 1.25 mm; no greater than 1.5 mm; no greater than 2 mm; no greater than 2.5 mm; no greater than 3 mm; and no greater than 5 mm.

Other ranges include beat lengths from 0.5 mm to 0.9 mm; from 0.5 mm to 1.5 mm; from 0.5 mm to 2 mm; from 0.5 mm to 2.5 mm; from 0.5 mm to 3 mm; and from 0.5 mm to 5 mm. Beat lengths can be from 1 mm to 5 mm, from greater than 1 mm to 5 mm; from 1.5 mm to 5 mm; from 2 mm to 5 mm; from 2.5 mm to 5 mm; and from 3 mm to 5 mm.

V-number and NA are parameters that are often specified for an optical fiber. V-number and NA, when discussed herein, refer to the V-number and the NA for the polarization of light that the apparatus of the invention is intended to provide, where the V-number and NA are measured when the fiber is substantially linearly oriented, unless otherwise specified.

The numerical aperture (NA) of a fiber is related to the acceptance angle of the fiber by the formula NA=sin Θₘₐₓ, where θₘₐₓ is the maximum angle of incidence for a ray that will be guided by the fiber. For a fiber having a first region having step refractive index profile relative to a second region cladding (e.g., the core relative to the cladding or first cladding relative to a second cladding) the NA can be calculated according to the formula:
NA=[(refractive index of first region)²−(refractive index of second region)²]^{1/2}
V-number can be described by a simple formula for most fibers:
V=(NA×radius of the core×2π)/free space wavelength of light

For a fiber having a core with a step refractive index profile relative to the cladding, a V-number of greater than 2.405 is generally understood in the art to correspond to a fiber core that can support or propagate more than one mode. Generally speaking, the higher the V-number, the higher the number of modes that the fiber can propagate.

In one practice, an optical fiber according to the invention (e.g., the optical fibers 12, 212, 312 and 412) can have a V-number at a wavelength, such as, for example, the wavelength at which the active material is intended to provide light responsive to being pumped, of no less than 3; no less than 3.5; no less than 4.0; no less than 4.5; no less than 5; no less than 7.5; and no less than 10. In some practices of the invention the V-number is no greater than 3; no greater than 3.5; no greater than 4; no greater than 4.5 no greater than 5; no greater than 7.5; and no greater than 10. The V-number can be from 3 to 5; from 5 to 7; from 7 to 10; from 3 to 10; from 5 to 10; from 7 to 10; and from 3 to 8.

In various practices of the invention, the core of a fiber according to the invention comprises a NA of no greater than 0.1; no greater than 0.09; no greater than 0.08; no greater than 0.07; no greater than 0.06; and no greater than 0.05. The NA can also be from 0.05 to 0.1; from 0.055 to 0.1; from 0.05 to 0.09; from 0.05 to 0.08; from 0.05 to 0.07; from 0.06 to 0.1; from 0.07 to 0.1; or from 0.08 to 0.1. Other possibilities include a NA from 0.06 to 0.08; or from 0.05 to 0.09.

The core of a fiber according to the present invention can have a diameter D₂ of at least 15 microns; at least 20 microns; at least 25 microns; at least 30 microns; at least 40 microns; at least 50 microns; at least 60 microns; at least 70 microns; at least 80 microns; and at least 90 microns. Other useful ranges for a core diameter D₂ include from 15 microns to 100 microns; from 20 microns to 90 microns; from 25 microns to 85 microns; from 30 microns to 80 microns; and from 40 microns to 70 microns. Additional ranges of interest include a core having a diameter of from 15 microns to 100 microns; from 15 microns to 90 microns; from 15 microns to 80 microns; from 15 microns to 70 microns; from 15 microns to 60 microns; from 15 microns to 50 microns; from 20 microns to 100 microns; from 25 microns to 100 microns; from 30 microns to 100 microns; from 40 microns to 100 microns; from 50 microns to 100 microns; from 60 microns to 100 microns; from 70 microns to 100 microns; or from 80 microns to 100 microns.

The beam quality of a fiber according to the invention, such as, for example, a fiber that supports more than one mode at the wavelength of operation (e.g., a fiber having a core comprising a NA and/or a diameter that allows more than one mode to be supported) can be improved by inducing sufficient bend loss to attenuate one or more of the higher order modes. See, for example, the techniques taught in U.S. Pat. No. 6,496,301, entitled “Helical Fiber Amplifier” and issued on Dec. 17, 2002 to Koplow, Kliner and Goldberg. The '301 patent involves positioning a fiber, which can have a large core and a low NA, to substantially attenuate, via bend loss, all higher order modes such that a fiber amplifier provides gain in substantially a single mode. Such a technique allows higher power operation of the fiber while maintaining the quality of the light provided by the fiber.

As noted above, silica is a typical host glass of the fiber cladding and/or core, to which other materials are added, such as rare earths and photosensitive material. However, many other materials can be added to silica to affect the index of refraction or the photosensitivity of the fiber. Known dopant materials used with silica include, but are not limited to, aluminum, phosphorus, titanium, tantalum (known to be photosensitive), the rare earths (such as, for example, erbium, ytterbium and lanthanum) and transition metals, which can be used to provide selected attenuation. In addition, other types of glass, such as, for example, chalcogenide glass, ZBLAN glass, phosphate glass, fluoride glass, germanium based glass and the like, as well as any of the single crystal or polycrystalline materials such as thallium bromoiodide, germanium, zinc selenide, antimony silicate and the like, may be found suitable for the host glass of the core or cladding of a fiber according to the invention.

More specifically, tin is known to be useful as a photosensitive material and can be added as dopant in many instances. Photosensitive materials useful, such as, for example, as dopants, with at least silica, even in the absence of germanium, include cerium, europium, aluminum, phosphorus and tantalum. Fluorozirconate fiber and silicon oxynitride fiber are also known to be photosensitive. By way of example, and not of limitation, an optical fiber according to the invention may comprise these or other materials, or variants thereof, singly or in combination in the core, cladding or other layers. Solution doping techniques noted above may be useful for incorporating photosensitive materials and/or rare earths such as those described above into an optical fiber preform.

Those skilled in the art will recognize or be able to ascertain using no more than routine experimentation many equivalents to the specific embodiments of the invention described herein. It is therefore to be understood that the foregoing embodiments are presented by way of example only and that within the scope of the appended claims and equivalents thereto, the invention may be practiced otherwise than as specifically described. The present invention is directed to each individual feature, system, material and/or method described herein. In addition, any combination of two or more such features, systems, materials and/or methods, if such features, systems, materials and/or methods are not mutually inconsistent, is included within the scope of the present invention.

In the claims as well as in the specification above all transitional phrases such as “comprising”, “including”, “carrying”, “having”, “containing”, “involving” and the like are understood to be open-ended. Only the transitional phrases “consisting of” and “consisting essentially of” shall be closed or semi-closed transitional phrases, respectively, as set forth in the U.S. Patent Office Manual of Patent Examining Procedure §2111.03, 7th Edition, Revision.

1. An optical fiber, comprising:
a core comprising an outer region disposed about an inner region, the inner region comprising a first index of refraction and the outer region comprising a second index of refraction that is greater than the first index of refraction;
a cladding disposed about the core;
the fiber further comprising a fundamental mode having an intensity profile at a first wavelength wherein the highest intensity of the intensity profile is no greater than 75% of the highest intensity of a Gaussian intensity profile normalized so as to have the same power as the intensity profile; and
wherein the outer region of the core comprises a first concentration of a selected rare earth and wherein any concentration of the selected rare earth comprised by the inner region is less than the first concentration.

2. The optical fiber of claim 1 wherein the highest intensity is no greater than 60% of the highest intensity of the Gaussian intensity profile.

3. The optical fiber of claim 1 wherein the inner region is substantially free of the selected rare earth.

4. The optical fiber claim 1 wherein the selected rare earth comprises erbium.

5. The optical fiber of claim 4 wherein the outer region comprises ytterbium.

6. The optical fiber of claim 1 wherein the highest intensity of the intensity profile is no greater than 50% of the highest intensity of the Gaussian intensity profile.

7. The optical fiber of claim 1 wherein the inner region is photosensitive, and the outer region, if photosensitive at all, has less than 50% of the photosensitivity of the inner region.

8. The optical fiber of claim 1 wherein the inner region is photosensitive, and the outer region, if photosensitive at all, has less than 10% of the photosensitivity of the inner region.

9. The optical fiber of claim 1 wherein the inner region comprises a selected concentration in weight percent of a selected photosensitive material, and wherein any concentration of the selected photosensitive material comprised by the outer region is less than the selected concentration.

10. The optical fiber of claim 1 wherein the inner region comprises a selected concentration in weight percent of a selected photosensitive material, and where any concentration of the selected photosensitive material comprised by the outer region is not greater than 50% of the selected concentration.

11. The optical fiber of claim 1 including a second cladding disposed about the cladding such that the cladding can guide light.

12. The optical fiber of claim 11 wherein the fiber is birefringent and extends along a longitudinal axis, the fiber comprising at least one longitudinally extending region for inducing stress.

13. The optical fiber of claim 11 wherein the second cladding is microstructured.

14. The optical fiber of claim 11 wherein the second cladding comprises longitudinally extending voids.

15. The optical fiber of claim 1 wherein the fiber is birefringent and extends along a longitudinal axis, the fiber comprising at least one longitudinally extending region for inducing stress.

16. An optical fiber, comprising:
a core comprising an outer region disposed about an inner region, the inner region comprising a first index of refraction and the outer region comprising a second index of refraction that is greater than the first index of refraction;
a cladding disposed about the. core;
the fiber further comprising a fundamental mode having an intensity profile at a first wavelength wherein the highest intensity of the intensity profile is no greater than 75% of the highest intensity of a Gaussian intensity profile normalized so as to have the same power as the intensity profile; and
wherein the outer region of the core is photosensitive and the inner region comprises a first rare earth and a second rare earth that is different than the first rare earth, and the inner region, if photosensitive at all, has no greater than 50% of the photosensitivity of the outer region.

17. The optical fiber of claim 16 wherein the outer region comprises a concentration of GeO₂.

18. The optical fiber of claim 17 wherein the outer region comprises at least one of a concentration of B₂O₃ and a concentration of fluorine.

19. The optical fiber of claim 16 wherein the inner region comprises erbium and ytterbium.

20. The optical fiber of claim 16 wherein the inner region, if photosensitive at all, has no greater than 25% of the photosensitivity of the outer region.

21. The optical fiber of claim 16 wherein any concentration comprised by the outer region of one of the first and second rare earths is substantially less than the concentration of the one of the first and second rare earths comprised by the inner region.

22. The optical fiber of claim 16 wherein the inner region, if photosensitive at all, has no more than 10% of the photosensitivity of the outer region.

23. The optical fiber of claim 16 wherein the outer region is substantially free of any rare earth.

24. The optical fiber of claim 16 including a second cladding disposed about the cladding such that the cladding can guide light.

25. The optical fiber of claim 24 wherein the fiber is birefringent and extends along a longitudinal axis, the fiber comprising at least one longitudinally extending region for inducing stress.

26. The optical fiber of claim 24 wherein the second cladding is microstructured.

27. The optical fiber of claim 24 wherein the second cladding comprises longitudinally extending voids.

28. The optical fiber of claim 16 wherein the fiber is birefringent and extends along a longitudinal axis, the fiber comprising at least one longitudinally extending region for inducing stress.

29. An optical fiber comprising:
a core extending along a longitudinal axis;
a cladding disposed about the core;
a refractive index profile comprising outer sections disposed about an inner section comprising a first index of refraction, the outer sections each having an index of refraction that is greater than the first index of refraction such that the optical fiber comprises at a first wavelength a fundamental mode having an intensity profile having a highest intensity that is no greater than 75% of the highest intensity of a Gaussian intensity profile normalized to have the same power as the intensity profile; and
wherein the fiber has a birefringence of at least 1×10⁻⁴ at wavelength of 633 nm.

30. The optical fiber of claim 29 wherein the cladding has a thermal coefficient of expansion (TCE), and wherein the fiber includes at least one longitudinally extending region having a TCE that is different than the TCE comprised by the cladding, the region for inducing stress for creating birefringence.

31. The optical fiber of claim 29 comprising a second cladding disposed about the cladding such that the cladding can guide light.

32. The optical fiber of claim 31 wherein the second cladding comprises a plurality of features having an index of refraction different than the index of refraction of the material of the second cladding disposed about the features.

33. The optical fiber of claim 32 wherein the features comprise voids.

34. An optical fiber comprising:
a core comprising an outer region disposed about an inner region;
a cladding disposed about the core;
the fiber comprising a fundamental mode having an intensity profile that has a reduced highest intensity relative to a Gaussian intensity normalized to have the same power as the intensity profile; and
wherein one of the inner and outer regions of the core comprises a first concentration of a selected rare earth and the other of the regions comprises a second concentration of a selected photosensitive material, any concentration of the selected rare earth comprised by the other region being less than the first concentration and any concentration of the selected photosensitive material comprised by the one region being less than the second concentration, and wherein when the selected photosensitive material comprises GeO₂ and the outer region comprises the second concentration of the selected photosensitive material, the second concentration is greater than 5 weight percent.

35. The optical fiber of claim 34 wherein the outer region comprises the second concentration of the selected photosensitive material.

36. The optical fiber of claim 35 wherein the outer region is substantially free of the selected rare earth.

37. The optical fiber of claim 34 wherein the inner region is substantially free of the selected photosensitive material.

38. The optical fiber of claim 37 wherein the outer region is substantially free of the selected rare earth.

39. The optical fiber of claim 34 wherein the outer region comprises the first concentration of the selected rare earth.

40. The optical fiber of claim 39 wherein the outer region is substantially free of the selected photosensitive material.

41. The optical fiber of claim 34 wherein the inner region is substantially free of the selected rare earth.

42. The optical fiber of claim 41 wherein the outer region is substantially free of the selected photosensitive material.

43. The optical fiber of claim 34 wherein the highest intensity of the intensity profile is no greater than 75% of the highest intensity of the normalized Gaussian intensity profile.
